(19) United States
(12) Patent Application Publication
(10) Pub. No.: US 2020/0017120 A1
(43) Pub. Date: Jan. 16, 2020

(54) Vehicle Speed Control Assembly

(71) Applicant: Joseph Maldonado, Lodi, NJ (US)

(72) Inventor: Joseph Maldonado, Lodi, NJ (US)

(21) Appl. No.: 16/032,208

(22) Filed: Jul. 11, 2018

(51) Int. Cl. B60W 50/08; B60W 30/14

(52) U.S. Cl. CPC B60W 50/087; B60W 10/04; B60W 30/143

(57) ABSTRACT

A vehicle speed control assembly for presetting cruise control parameters includes a vehicle equipped with an on-board computer system, a wireless communication system, a global positioning system receiver, and a cruise control system. The on-board computer system is operationally coupled to the wireless communication system, the global positioning system receiver, and the cruise control system. Programming code is positioned on an electronic device of a user. The programming code enables the user to wirelessly communicate operational parameters for the cruise control system through the wireless communication system to the on-board computer system. The assembly permits the user to preset the cruise control system in a safe manner prior to operating the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to control assemblies and more particularly pertains to a new control assembly for presetting cruise control parameters.

### BRIEF SUMMARY OF THE INVENTION

An embodiment of the disclosure meets the needs presented above by generally comprising a vehicle equipped with an on-board computer system, a wireless communication system, a global positioning system receiver, and a cruise control system. The on-board computer system is operationally coupled to the wireless communication system, the global positioning system receiver, and the cruise control system. Programming code is positioned on an electronic device of a user. The programming code enables the user to wirelessly communicate operational parameters for the cruise control system through the wireless communication system to the on-board computer system. The assembly permits the user to preset the cruise control system in a safe manner prior to operating the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a vehicle speed control assembly according to an embodiment of the disclosure.

FIG. 2 is a detail view of an embodiment of the disclosure.

FIG. 3 is a block diagram view of an embodiment of the disclosure.

### DETAILED DESCRIPTION OF THE INVENTION

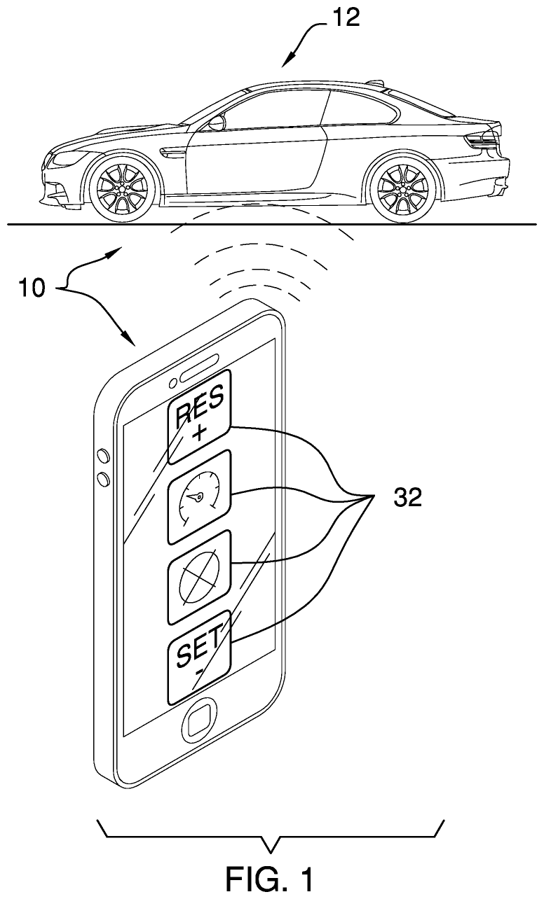

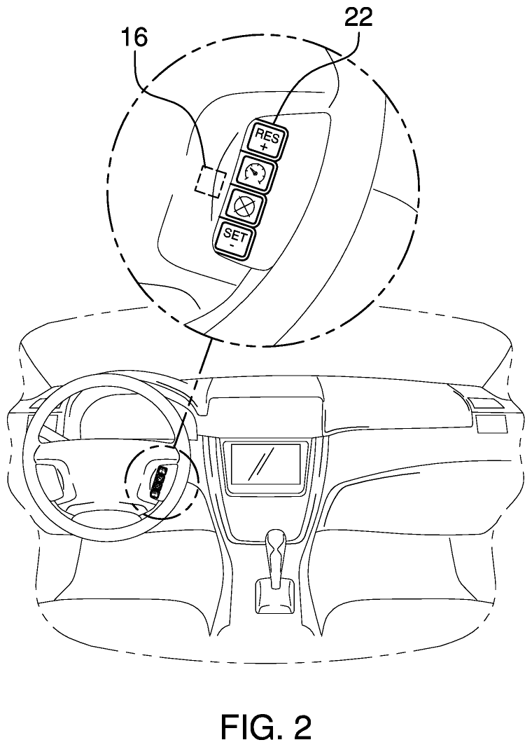

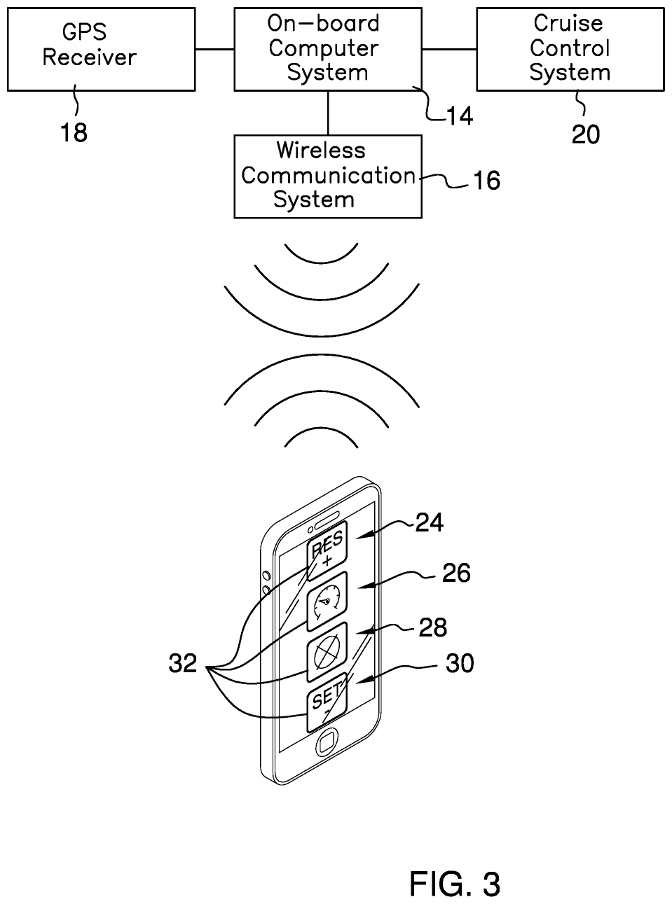

With reference now to the drawings, and in particular to FIGS. 1 through 3 thereof, a new control assembly embodying the principles and concepts of an embodiment of the disclosure and generally designated by the reference numeral 10 will be described.

As best illustrated in FIGS. 1 through 3, the vehicle speed control assembly 10 generally comprises a vehicle 12 that is equipped with an on-board computer system 14, a wireless communication system 16, a global positioning system receiver 18, and a cruise control system 20. The on-board computer system 14 is operationally coupled to the wireless communication system 16, the global positioning system receiver 18, and the cruise control system 20.

A controller 22 is coupled to the vehicle 12. The controller 22 is operationally coupled to the on-board computer system 14. The controller 22 is configured for a user to input commands into the on-board computer system 14 to selectively actuate the cruise control system 20 and to set operational parameters for the cruise control system 20.

Programming code 24 is positioned on an electronic device of the user that enables the user to wirelessly communicate the operational parameters for the cruise control system 20 through the wireless communication system 16 to the on-board computer system 14. The assembly 10 permits the user to preset the cruise control system 20 in a safe manner prior to operating the vehicle 12. For example, with the programming code 24 positioned on a smartphone of the user, the user can communicate the operational parameters for the cruise control system 20 through the wireless communication system 16 to the on-board computer system 14 from outside of the vehicle 12 prior to driving the vehicle 12.

A static control aspect 26 of the programming code 24 enables the user to wirelessly communicate a speed to be maintained by the cruise control system 20 for the vehicle 12. Actuating the cruise control system 20 via the controller 22 instructs the on-board computer system 14 to command the cruise control system 20 to substantially maintain the speed set by the user. The user may choose to utilize the static control aspect 26 of the programming code 24 when a trip is planned to set the speeds to be maintained by the cruise control system 20 for various segments of the trip.

A dynamic control aspect 28 of the programming code 24 enables the user to wirelessly communicate an operating mode to be implemented by the cruise control system 20. Actuating the cruise control system 20 via the controller 22 instructs the on-board computer system 14 to receive coordinates from the global positioning system receiver 18 so that a speed limit for a location corresponding to the coordinates is determined and communicated to the cruise control system 20 to substantially maintain the vehicle 12 at a speed corresponding to the speed limit at the location.

A rendering aspect 30 of the programming code 24 enables the user to launch an on-screen control module 32 that substantially duplicates the controller 22. The user is enabled to input the commands into the on-board computer system 14 to set the operational parameters for the cruise control system 20.

The programming code 24 is not limited to the static control aspect 26, the dynamic control aspect 28, and the rendering aspect 30 of the programming code 24. Cruise control technology is an evolving field that encompasses an ever-increasing number of modes of operation for the cruise control system 20. The present invention anticipates programming code 24 to wirelessly communicate the operational parameters for these of modes of operation for the cruise control system 20 through the wireless communication system 16 to the on-board computer system 14.

In use, the user uses the electronic device to wirelessly communicate the operational parameters for the cruise control system 20 through the wireless communication system 16 to the on-board computer system 14. Actuating the cruise control system 20 via the controller 22 instructs the on-board computer system 14 to command the cruise control system 20 the implement the operational parameters.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle speed control assembly comprising:
a vehicle equipped with an on-board computer system, a wireless communication system, a global positioning system receiver, and a cruise control system, the on-board computer system being operationally coupled to the wireless communication system, the global positioning system receiver, and the cruise control system; and
programming code positioned on an electronic device of a user enabling the user for wirelessly communicating operational parameters for the cruise control system through the wireless communication system to the on-board computer system.

2. The assembly of claim 1, further including a controller coupled to the vehicle, the controller being operationally coupled to the on-board computer system wherein the controller is configured for inputting commands into the on-board computer system for selectively actuating the cruise control system and for setting the operational parameters for the cruise control system.

3. The assembly of claim 2, further including a static control aspect of the programming code enabling the user for wirelessly communicating a speed to be maintained by the cruise control system for the vehicle wherein activating the cruise control system via the controller commands the cruise control system for substantially maintaining the speed set by the user.

4. The assembly of claim 2, further including a dynamic control aspect of the programming code enabling the user for wirelessly communicating an operating mode to be implemented by the cruise control system wherein activating the cruise control system via the controller instructs the on-board computer system for receiving coordinates from the global positioning system receiver such that a speed limit for a location corresponding to the coordinates is determined and communicated to the cruise control system for substantially maintaining the vehicle at a speed corresponding to the speed limit at the location.

5. The assembly of claim 2, further including a rendering aspect of the programming code enabling the user for launching an on-screen control module substantially duplicating the controller wherein the user is enabled for inputting the commands into the on-board computer system for setting the operational parameters for the cruise control system.

6. A vehicle speed control assembly comprising:
a vehicle equipped with an on-board computer system, a wireless communication system, a global positioning system receiver, and a cruise control system, the on-board computer system being operationally coupled to the wireless communication system, the global positioning system receiver, and the cruise control system;
a controller coupled to the vehicle, the controller being operationally coupled to the on-board computer system wherein the controller is configured for inputting commands into the on-board computer system for selectively actuating the cruise control system and for setting operational parameters for the cruise control system; and
programming code positioned on an electronic device of a user enabling the user for wirelessly communicating the operational parameters for the cruise control system through the wireless communication system to the on-board computer system, a static control aspect of the programming code enabling the user for wirelessly communicating a speed to be maintained by the cruise control system for the vehicle wherein activating the cruise control system via the controller commands the cruise control system for substantially maintaining the speed set by the user, a dynamic control aspect of the programming code enabling the user for wirelessly communicating an operating mode to be implemented by the cruise control system wherein activating the cruise control system via the controller instructs the on-board computer system for receiving coordinates from the global positioning system receiver such that a speed limit for a location corresponding to the coordinates is determined and communicated to the cruise control system for substantially maintaining the vehicle at a speed corresponding to the speed limit at the location, a rendering aspect of the programming code enabling the user for launching an on-screen control module substantially duplicating the controller wherein the user is enabled for inputting the commands into the on-board computer system for setting the operational parameters for the cruise control system.
